(19) United States
(12) Patent Application Publication
(10) Pub. No.: US 2023/0394443 A1
(43) Pub. Date: Dec. 7, 2023

(54) VEHICLE MANAGEMENT SYSTEM

(71) Applicant: TOYOTA JIDOSHA KABUSHIKI KAISHA, Toyota-shi Aichi-ken (JP)

(72) Inventors: Yukinari KATO, Okazaki-shi Aichi-ken (JP); Shintaro MATSUTANI, Kariya-shi Aichi-ken (JP); Keiichi UNO, Chita-gun Aichi-ken (JP)

(73) Assignee: TOYOTA JIDOSHA KABUSHIKI KAISHA, Toyota-shi Aichi-ken (JP)

(21) Appl. No.: 18/135,274

(22) Filed: Apr. 17, 2023

(30) Foreign Application Priority Data
Jun. 21, 2022 (JP) 2022-099488

(51) Int. Cl. G06Q 10/20; G07C 5/00; G07C 5/04; G06Q 50/30

(52) U.S. Cl. CPC G06Q 10/20; G07C 5/008; G07C 5/04; G06Q 50/30

(57) ABSTRACT

When a vehicle allocation request is made, a management server executes a process including: a step of acquiring operation information; a step of acquiring a traveling route of a vehicle allocation destination, and a step of calculating an accumulated amount of load; a step of setting a vehicle with a low accumulated amount as an allocated vehicle when the traveling route of the vehicle allocation destination has a high load; a step of setting a vehicle with a high accumulated amount as an allocated vehicle when the traveling route of the vehicle allocation destination is not a high load; and a step of transmitting the travel plan information.

### CROSS-REFERENCE TO RELATED APPLICATION

This application claims priority to Japanese Patent Application No. 2022-099488 filed on Jun. 21, 2022, incorporated herein by reference in its entirety.

### BACKGROUND

### 1. Technical Field

The present disclosure relates to a vehicle management system.

### 2. Description of Related Art

When a vehicle is used to provide transportation services, etc., maintenance such as replacement of consumables and adjustment of vehicle parts is performed periodically. However, the vehicle cannot be used to provide services during the maintenance period. Thus, the opportunity to provide services may be lost. Therefore, it is desired that vehicle maintenance be performed at an appropriate timing in accordance with a demand state of service provision or in consideration of the service provision status using multiple vehicles in the case where services are provided using multiple vehicles.

Japanese Unexamined Patent Application Publication No. 2020-013373 (JP 2020-013373 A) discloses a vehicle maintenance management system that gives an instruction for maintenance to be performed by using vehicle usage information.

### SUMMARY

In the vehicles used for providing the above-mentioned service, when the vehicles continue to be used under a high load state, a risk of failure is increased. When an unexpected vehicle maintenance is performed due to the failure, the time that cannot be used to provide a service is increased.

The present disclosure has been made to solve the above-described problems, and an object thereof is to provide a vehicle management system that suppresses an increase in time that cannot be used to provide a service.

A vehicle management system according to an aspect of the present disclosure includes a plurality of vehicle used to provide a transportation service and a server that is able to communicate with the vehicles. The server calculates an accumulated amount of a load of each of the vehicles when provision of the transportation service using the vehicles on a plurality of traveling routes is required. The server allocates a vehicle in which the accumulated amount is large among the vehicles with priority over a vehicle in which the accumulated amount is small, for a traveling route in which a load degree indicating a degree of a load acting on the vehicle when the vehicle is traveling, among the traveling routes.

In this way, since the accumulated amount of the load in the vehicles can be made uniform, the risk of failure due to the concentration of load on some vehicles can be reduced. As a result, it is possible to avoid unexpected maintenance from being performed, and suppress an increase in the time that cannot be used to provide the service.

In one embodiment, the server calculates the accumulated amount of the load of each of the vehicles by using a travel history of each of the vehicles.

In this way, it is possible to calculate the accumulated amount of the load of each of the vehicles with high accuracy.

Further, in some embodiments, the vehicle includes an autonomous driving vehicle.

In this way, it is possible to avoid unexpected maintenance from being performed in the autonomous driving vehicle, and suppress an increase in the time that cannot be used to provide the service.

According to the present disclosure, it is possible to provide a vehicle management system that suppresses an increase in time that cannot be used to provide a service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an overall configuration of a vehicle management system;

FIG. 2 is a diagram showing an example of a configuration of an autonomous driving kit (ADK) and a vehicle platform (VP) in more detail;

FIG. 3 is a flowchart showing an example of a process executed by a management server; and

FIG. 4 is a diagram for describing allocation of a vehicle to a plurality of traveling routes.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

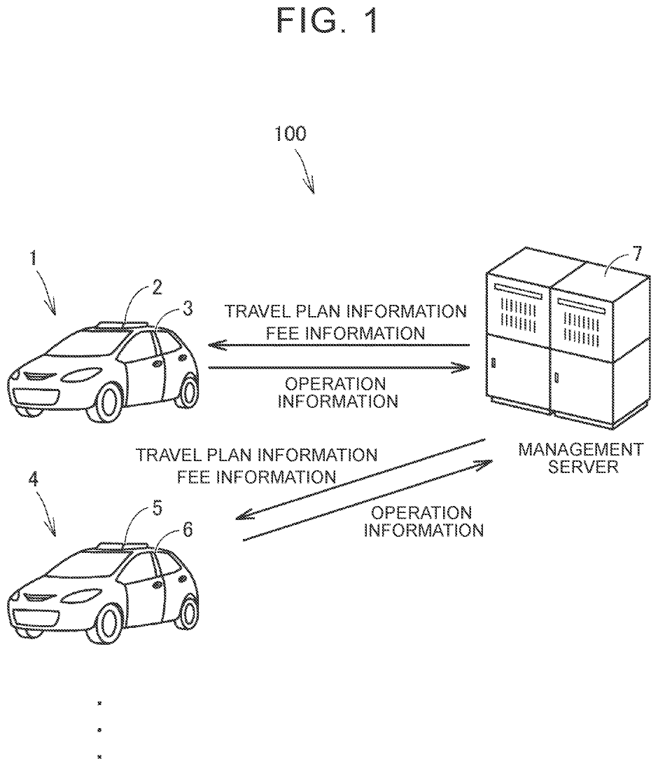

FIG. 1 is a diagram schematically showing an overall configuration of a vehicle management system 100. The vehicle management system 100 manages a plurality of vehicles. In practice, many vehicles can be managed by the vehicle management system 100, but for convenience of explanation, a case where specific vehicles 1 and 4 are managed by the vehicle management system 100 will be described below as an example. The vehicle management system 100 includes the vehicles 1 and 4 and a management server 7. The vehicle 1 includes an autonomous driving kit (ADK) 2 and a vehicle platform (VP) 3. Similarly, the vehicle 4 includes an ADK 5 and a VP 6.

The users of the vehicles 1 and 4 may be, for example, businesses that provide transportation services by autonomous driving by using the vehicles 1 and 4 (bus businesses, taxi businesses, rental car businesses, car sharing businesses, or ride sharing services business operators, etc.). In the present embodiment, it is assumed that users of the vehicles 1 and 4 are, for example, business operators who own a plurality of vehicles and provide personnel transportation services. A transportation service for people is, for example, driving a vehicle along multiple traveling routes (such as traveling route that passes through an urban area and a traveling route that passes through a mountainous area), and having people load and alight at a predetermined boarding/alighting point provided on the traveling routes while moving so as to arrive at the predetermined boarding/alighting point set on the traveling route at a predetermined set time, and charging a usage fee.

An example of a configuration for autonomous driving will be described below, with the vehicle 1 serving as an example. The ADK 2 mounted on the vehicle 1 is configured to be attachable to the VP 3 of the vehicle 1 and detachable from the VP 3. The ADK 2 is attached to a predetermined position such as the rooftop of VP 3, for example.

The ADK 2 is configured to enable autonomous driving of the vehicle 1. Specifically, the ADK 2 creates a travel plan for the vehicle 1. The ADK 2 outputs various control requests for causing the vehicle 1 to travel in accordance with the travel plan to the VP 3, following an application program interface (API) defined for each control request. The ADK 2 also receives various signals indicating the vehicle state (state of VP 3) from the VP 3 in accordance with an API defined for each signal. The ADK 2 then reflects the vehicle state on the travel plan. The ADK 2 may create a travel plan using the travel plan information from the management server 7, for example.

The VP 3 executes traveling control in the autonomous driving mode according to the control request from ADK 2. When the ADK 2 is removed from the VP 3, the VP 3 is configured to be able to execute a traveling control in manual mode (a traveling control according to the driver's operation).

The VP 3 transmits various types of information (operation information and the like, which will be described later) to the management server 7 in the vehicle management system 100.

The management server 7 may be a company's own server, a shared server shared by a plurality of companies including the above company, or a cloud server provided by a cloud server management company.

The management server 7 is, for example, a server operated by an operator who maintains and manages a plurality of vehicles including the vehicle 1. The business operator may be, for example, the VP 3 manufacturer or the ADK 2 manufacturer. Furthermore, the management server 7 may be configured to include a server operated by the manufacturer of VP 3 and the server operating ADK 2. In the following description, an example in which the management server 7 is configured of one server will be described.

The management server 7 is configured to be able to receive operation information from each of the vehicles 1 and 4. The operation information of the vehicles 1 and 4 includes information that can identify the vehicles 1 and 4 such as license plate numbers and manufacturing numbers (hereinafter referred to as a vehicle ID), information on a driving history (hereinafter referred to as history information) such as a traveling time and a traveling distance, and information on maintenance of the vehicles 1 and 4 (hereinafter referred to as maintenance information). The management server 7 includes a database (not shown) for storing operation information received from at least one of the vehicles 1 and 4 in a format that allows identification of the vehicle that sent the information. The management server 7 generates the travel plan information and fee information by using the received operation information, and transmits them to the vehicles 1 and 4.

In the present disclosure, “maintenance” of a vehicle means all actions for maintaining the vehicle in a normal state and restoring the vehicle from an abnormal state to a normal state. Maintenance may include inspection, repair, adjustment, or replacement of any part provided on the vehicle. The maintenance information may include, for example, information for diagnosing whether maintenance is required, such as a mileage after maintenance of a part that is the maintenance target, a mileage until a next maintenance of the part, and the like, and may include information indicating a diagnosis result as to whether maintenance is required.

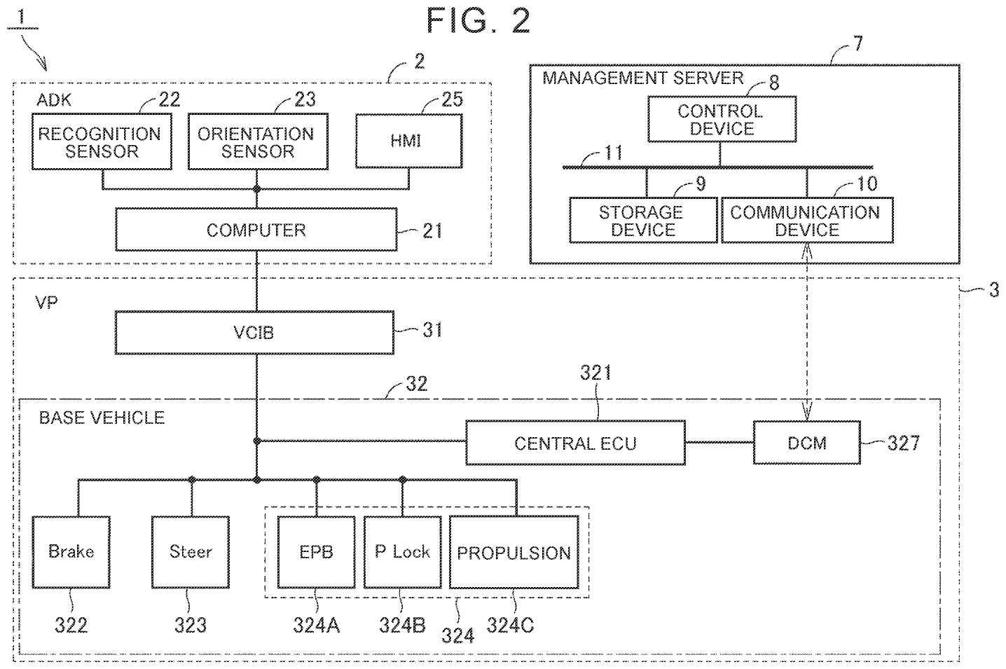

FIG. 2 is a diagram showing an example of a configuration of the ADK 2 and the VP 3 in more detail. The ADK 2 includes a computer 21, a recognition sensor 22, an orientation sensor 23, and a human machine interface (HMI) 25.

The VP 3 includes a vehicle control interface box (VCIB) 31 and a base vehicle 32. The base vehicle 32 includes a central electronic control unit (ECU) 321, a braking system 322, a steering system 323, a powertrain system 324, and a digital communication system (DCM) 327.

The powertrain system 324 includes an electric parking brake (EPB) system 324A, a parking lock (P-lock) system 324B, and a propulsion system 324C.

The computer 21 acquires data regarding the environment of the vehicle 1 by using the recognition sensor 22 during autonomous driving of the vehicle 1. In addition, the computer 21 acquires data on the orientation, behavior and position of the vehicle 1 by using orientation sensor 23 during autonomous driving of the vehicle 1. Furthermore, the computer 21 is communicably connected to the VCIB 31. The computer 21 acquires the vehicle state from the VP 3 via the VCIB 31 and sets the next operation (acceleration, deceleration, turning, etc.) of the vehicle 1. The computer 21 outputs various commands to the VP 3 via the VCIB 31 to implement the following operations.

The recognition sensor 22 is a sensor for recognizing the environment of the vehicle 1. The recognition sensor 22 includes, for example, at least one of a laser imaging detection and ranging (LIDAR), a millimeter wave radar, and a camera (all not shown). The LIDAR emits, for example, infrared pulsed laser light and measures the distance and the direction of an object by detecting the reflected light of the laser light from the object. The millimeter wave radar measures the distance and the direction of an object by emitting millimeter waves and detecting the reflected waves of the millimeter waves from the object. The camera captures an image ahead of the vehicle 1.

The orientation sensor 23 is a sensor for detecting the orientation, behavior, and position of the vehicle 1. The orientation sensor 23 includes, for example, an inertial measurement unit (IMU) and a position detection device such as a global positioning system (GPS) (both not shown). The IMU detects, for example, the longitudinal, lateral, and vertical accelerations of the vehicle 1 and the angular velocities of the vehicle 1 in the roll, pitch, and yaw directions. The GPS locates the vehicle 1 using information received from multiple GPS satellites orbiting the earth.

The HMI 25 is configured to be connected to an input/output device (not shown) such as a touch panel display provided on the base vehicle 32, for example.

The VCIB 31 is communicably connected to the ADK 2 through controller area network (CAN) or the like. The VCIB 31 receives various control requests from the ADK 2 and outputs the vehicle state to the ADK 2 by executing a predetermined API defined for each signal. Upon receiving a control request from the ADK 2, the VCIB 31 outputs a control command corresponding to the control request to a system (for example, a braking system 322, a steering system 323, and a powertrain system 324) corresponding to the control command. Also, the VCIB 31 acquires various types of information about the vehicle state (the state of the base vehicle 32) and outputs the acquired information to the ADK 2.

The central ECU 321 transmits various information indicating the vehicle state to the management server 7 and various requests to the management server 7, via the DCM 327. The central ECU 321 also receives commands or notifications from the management server 7 via the DCM 327. Further, the central ECU 321 uses the vehicle state acquired from each system of the VP 3 to diagnose whether maintenance is required in the VP 3, or receives the diagnosis result of the self-diagnosis performed in each system of the VP 3 to use the received diagnosis result so as to diagnose whether the state is such that maintenance is required in the VP 3.

In the present embodiment, the central ECU 321 will be described as an executing entity of diagnostic processing for diagnosing whether maintenance of the vehicle 1 is required. However, in addition to the above function, the central ECU 321 may have a function (gateway function) such as relaying communication between ECUs included in each system.

The braking system 322 is configured to control braking devices (not shown) provided on each wheel of the base vehicle 32. The steering system 323 is configured to control a steering angle of steered wheels of the vehicle 1 using a steering device (not shown).

The EPB system 324A controls an EPB (not shown) provided on at least one of the wheels following a control request transmitted from the ADK 2 via the VCIB 31. The P-lock system 324B controls a P-lock device (not shown) provided in the transmission following a control request transmitted from the ADK 2 through the VCIB 31. The propulsion system 324C controls a driving force from a drive source (such as a motor generator and an engine, which are not shown) following the control request/requirement from the ADK 2.

The DCM 327 is an in-vehicle communication module. The DCM 327 is configured to enable two-way data communication between the central ECU 321 and the management server 7.

The ADK 5 of the vehicle 4 has the same configuration as the ADK 2 of the vehicle 1. Furthermore, the VP 6 of the vehicle 4 has the same configuration as the VP 3 of the vehicle 1. Therefore, detailed descriptions thereof will not be repeated.

The management server 7 includes a control device 8, a storage device 9 and a communication device 10. The control device 8, the storage device 9 and the communication device 10 are communicably connected to each other via a communication bus 11.

The control device 8 includes a central processing unit (CPU), a memory (read only memory (ROM), a random access memory (RAM), etc.), input/output ports for inputting and outputting various signals, etc., although none of them are shown. Various controls that are executed by the control device 8 are executed by software processing, that is, programs stored in the memory are read out by the CPU. The various controls by the control device 8 can also be realized by a general-purpose computer (not shown) executing a program stored in a storage medium. The various controls by the control device 8 are not limited to software processing, and may be processed by dedicated hardware (electronic circuits).

The storage device 9 stores operation information received from the vehicles 1 and 4 configured to be able to communicate with the management server 7.

The communication device 10 realizes two-way communication between the vehicles 1 and 4 and a communication network (not shown). The management server 7 enables a plurality of vehicles including the vehicles 1 and 4 to communicate with each other via a base station (not shown) provided in a communication network by using the communication device 10.

In the vehicle management system 100 having the configuration described above, for example, the management server 7 sets a traveling route indicating route information on which each of the vehicles 1 and 4 travels, and transmits travel plan information to each of the vehicles 1 and 4 so as to arrive at or depart from boarding/alighting points on the set traveling route at preset times. Furthermore, the management server 7 transmits to the vehicles 1 and 4, information about the usage fee of the vehicle on the set traveling route as fee information.

In each of the vehicles 1 and 4, autonomous driving is carried out following the travel plan information, fee information is presented to the user by using a display device or the like, and settlement processing is executed in accordance with the usage by the user. In this way, in each of the vehicles 1 and 4, the user gets on and off at the boarding/alighting points, and the transportation service for the personnel moving on the traveling route is provided.

When a plurality of vehicles, including the vehicles 1 and 4, are used to provide personnel transportation services, maintenance of the vehicles 1 and 4 is performed on a regular basis.

For example, whether maintenance of the vehicles 1 and 4 is necessary is determined by diagnosing whether each of the vehicles 1 and 4 is in a state requiring maintenance in the vehicles 1 and 4 or management server 7.

Cases of diagnosing whether the vehicle 1 is in a state requiring maintenance include when a usage period of a diagnostic target part exceeds a threshold from the time of the last replacement, when an amount of consumption of the diagnostic target part since the last replacement exceeds a threshold, when the error code of the part to be diagnosed is output, or when the output value of a component that is a diagnostic target becomes abnormal.

For example, when the usage period of various oils used in the engine, the motor generator, etc. from the time of the previous replacement exceeds a threshold set in accordance with the type of oil and the vehicle type, the diagnosis is that maintenance for oil replacement is required. Alternatively, when an amount of wear of the brake pads included in the braking device exceeds a threshold value, it is diagnosed that maintenance for replacement of the brake pads is required. Alternatively, when a predetermined error code is output from equipment related to the driving operation of the vehicle 1, such as the engine and the motor generator, it is diagnosed that inspection and maintenance are required. Alternatively, when output values of various sensors exceed a normal range, it is diagnosed that maintenance such as sensor replacement or adjustment is required.

These determinations are made using the diagnostic results of self-diagnostic processing executed in the vehicle 1. The self-diagnostic process is executed, for example, by the computer 21 of the ADK 2 or the central ECU 321 of the VP 3. Alternatively, the management server 7 may manage information about the maintenance history of the vehicles 1 and 4, execute diagnostic processing by using the managed information, and use the diagnostic result to determined whether maintenance is required.

However, when it is diagnosed that maintenance is required as described above and maintenance is carried out, the vehicles 1 and 4 cannot be used to provide the service during the period of maintenance. Thus, the opportunity to provide the service is lost. Therefore, it is required to perform vehicle maintenance at an appropriate timing in consideration of the service provision demand and the service provision status.

In the vehicles 1 and 4 used for providing the above-mentioned service, when the vehicles 1 and 4 continue to be used under a high load state, a risk of failure is increased. When an unexpected vehicle maintenance is performed due to the failure, the time that cannot be used to provide a service is increased.

Therefore, in the present embodiment, it is assumed that the management server 7 operates as follows. In other words, the management server 7 calculates the load accumulated amount for each of the plurality of vehicles when provision of the transportation service using the plurality of vehicles on the plurality of traveling routes is requested. Furthermore, among the plurality of traveling routes, for the traveling route in which the load degree that indicates the load degree acting on the vehicle when traveling, the management server 7 allocates the vehicle with the large accumulated amount among the plurality of vehicles preferentially over the vehicle with the small accumulated amount.

In this way, since the accumulated amount of the load in the plurality of vehicles can be made uniform, the risk of failure due to the concentration of load on some vehicles can be reduced. As a result, it is possible to avoid unexpected maintenance from being performed, and suppress an increase in the time that cannot be used to provide the service.

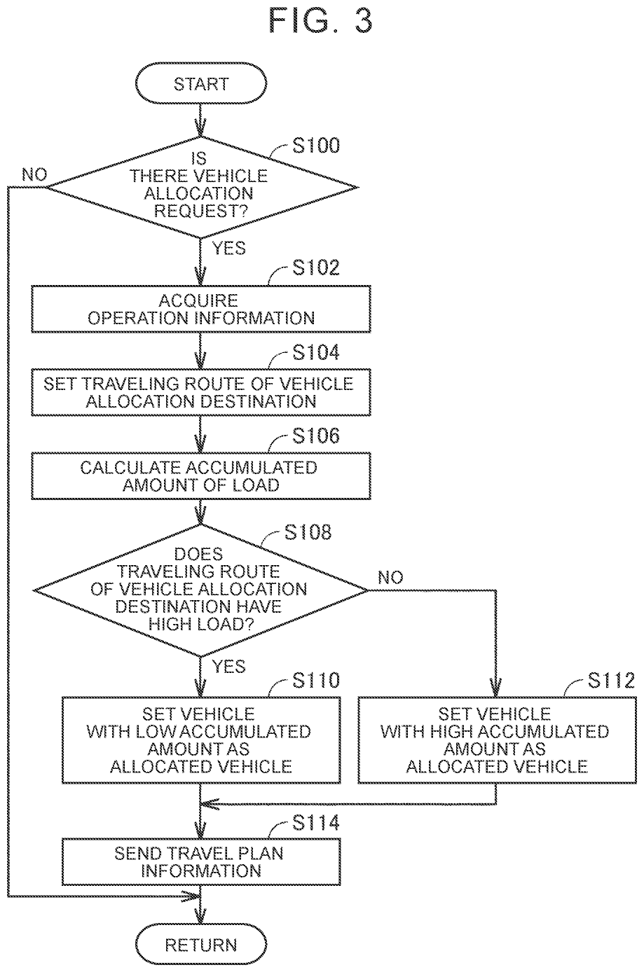

An example of processing executed in the management server 7 will be described below with reference to FIG. 3. FIG. 3 is a flowchart showing an example of a process executed by the management server 7. A series of processes shown in this flowchart are repeatedly executed by the management server 7 at predetermined intervals.

At step (hereinafter, step will be referred to as S) 100, the management server 7 (more specifically, the control device 8 of the management server 7) determines whether there is a vehicle allocation request. For example, when the management server 7 receives information indicating that the vehicle is in a state requiring maintenance from one of the vehicles traveling on the plurality of traveling routes (providing transportation services), or when the management server 7 determines that one of the vehicles is in a state requiring maintenance by using the information received from the vehicle traveling on one of the plurality of traveling routes among the plurality of vehicles, it is determined that there is a vehicle allocation request. When it is determined that there is a vehicle allocation request (YES at S100), the process proceeds to S102.

In S102, the management server 7 acquires the operation information. The management server 7 acquires the operation information from each of a plurality of vehicles including the vehicles 1 and 4. For example, when the management server 7 requests the operation information from the vehicle 1 via the communication device 10, the central ECU 321 of the vehicle 1 receives the request signal from the management server 7 via the DCM 32. The central ECU 321 acquires the operation information from the computer 21 of the ADK 2 or the memory of the central ECU 321, for example, and transmits the acquired operation information to the management server 7 via the DCM 32. After that, the process moves to S104.

In S104, the management server 7 acquires information on the traveling route of the vehicle allocation destination. The management server 7 uses the vehicle allocation request to identify the traveling route of the vehicle allocation destination. The management server 7 may, for example, identify a vehicle that is in a state that requires maintenance, and identify the traveling route of the identified vehicle as the traveling route of the vehicle allocation destination. After that, the process moves to S106.

In S106, the management server 7 calculates the accumulated amount of load of each of the plurality of vehicles. The management server 7 calculates, for example, the accumulated amount of the load of each vehicle other than the vehicle requiring maintenance among the plurality of vehicles. The management server 7 calculates the accumulated amount of the load by using information that is at least one a plurality of pieces of traveling history that are the traveling distance, the traveling time, the vehicle weight, the total number of passengers, the traveling distance until the next maintenance is performed, and the traveling time unit the next maintenance is performed. The management server 7 may calculate, for example, a two-stage accumulated amount including a high accumulation state and a low accumulation state. For example, the management server 7 may set a high accumulation state when the traveling distance is equal to or greater than a threshold, and may set a low accumulation state when the traveling distance is shorter than the threshold. The management server 7 may, for example, calculate the accumulated amount in three or more levels by setting a plurality of thresholds, or may calculate the accumulated amount shown as a percentage, for example. For example, the management server 7 may use at least one of the plurality of pieces of travel history information to calculate the basic value of the accumulated amount, may use the other travel history information to set the correction coefficient, and may calculate the accumulated amount expressed as the percentage by correcting the basic value by using a correction factor. For example, the management server 7 associates the calculated accumulated amount with the vehicle ID of the corresponding vehicle and stores them in the storage device 9. After that, the process moves to S108.

In S108, the management server 7 determines whether the traveling route of the vehicle allocation destination is the high load traveling route. The management server 7 may determine whether the traveling route of the vehicle allocation destination is the high load traveling route, based on a state of a flag (for example, a flag that is turned on when the route is the high load route) that is preset for each of the plurality of traveling routes and that indicates that the traveling route is the high load route. Alternatively, for example, the management server 7 may determine that the traveling route of the vehicle allocation destination is the high load traveling route when there is an upward hill in which an altitude difference is equal to or greater than a threshold value. Alternatively, the management server 7 may determine that the traveling route is the high load traveling route when the traveling distance is equal to or greater than a threshold value. Alternatively, the management server 7 may determine that the traveling route is the high-load traveling route when the number of occurrences of waiting for a traffic light is equal to or greater than a threshold value by using an execution history of waiting for a traffic light for each time the vehicle travels on the traveling route to the vehicle allocation destination. When it is determined that the traveling route of the vehicle allocation destination is the high load traveling route (YES in S108), the process proceeds to S110.

At S110, the management server 7 sets the vehicle with the low accumulated amount as the allocated vehicle for the traveling route of the vehicle allocation destination. For example, the management server 7 ranks the accumulated amount of each vehicle stored in the storage device 9 so that the magnitude relationship can be specified. Then, the management server 7 may set, for example, the vehicle with the lowest accumulated amount as the allocated vehicle for the traveling route of the vehicle allocation destination. For example, the management server 7 may set the vehicle with the shortest travel distance as the allocated vehicle, or may set the vehicle with the shortest travel time as the allocated vehicle. For example, when there is a plurality of options for low accumulated amount vehicles, the management server 7 may set vehicles with high priority as the allocated vehicle, in accordance with the priority set by the predetermined criteria for selecting the low accumulated amount vehicles. After that, the process moves to S114.

In S112, the management server 7 sets the vehicle with the high accumulated amount as the allocated vehicle for the traveling route of the vehicle allocation destination. For example, the management server 7 ranks the accumulated amount of each vehicle stored in the storage device 9 so that the magnitude relationship can be specified. Then, the management server 7 may set, for example, the vehicle with the highest accumulated amount as the allocated vehicle for the traveling route of the vehicle allocation destination. For example, the management server 7 may set the vehicle with the longest travel distance as the allocated vehicle, or may set the vehicle with the longest travel time as the allocated vehicle. For example, when there is a plurality of options for high accumulated amount vehicles, the management server 7 may set vehicles with high priority as the allocated vehicle, in accordance with the priority set by the predetermined criteria for selecting the high accumulated amount vehicles. After that, the process moves to S114.

At S114, the management server 7 transmits the travel plan information to the allocated vehicle. The management server 7 sets, for example, the arrival and departure times at each boarding/alighting point set in the traveling route of the vehicle allocation destination. For example, the management server 7 sets the same departure/arrival times as the departure/arrival times at each boarding/alighting point on the traveling route of the vehicle allocation destination set for the vehicle that requires maintenance when determining that there is a vehicle allocation request. The management server 7 transmits information on the traveling route of the vehicle allocation destination and information such as the above-mentioned departure/arrival times as the travel plan information to the allocated vehicle. The process is then terminated. When it is determined that there is no vehicle allocation request (NO in S100), this process is ended.

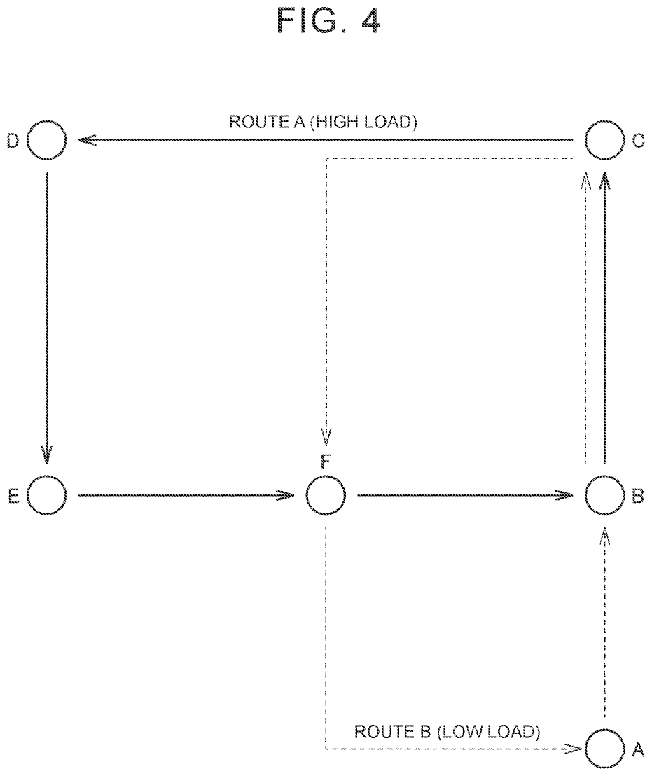

An example of the operation of the management server 7 based on the above structure and flowchart will be described with reference to FIG. 4.

FIG. 4 is a diagram for explaining allocation of vehicles to a plurality of traveling routes. (A) to (F) of FIG. 4 show an example of boarding/alighting points. FIG. 4 shows a high-load A route and a low-load B route as examples of traveling routes.

In route A in FIG. 4, the vehicle moves between the boarding/alighting points in the order of (B), (C), (D), and (E) in FIG. 4, for example, as indicated by solid line arrows in FIG. 4 and return to (B), and circulates.

On route B in FIG. 4, the vehicle moves between the boarding/alighting points in the order of (A), (B), (C), and (F) in FIG. 4, for example, as indicated by the dashed arrows in FIG. 4 and then return to (A), and circulates.

For example, it is assumed that the vehicle 1, which is circuiting route A, of the plurality of vehicles is determined to be in a state requiring maintenance by the self-diagnostic processing.

At this time, when management server 7 receives information indicating that maintenance is required from vehicle 1, it determines that there is a vehicle allocation request (YES in S100). Therefore, the operation information is acquired from the plurality of vehicles (S102), and it is acquired that the traveling route of the vehicle allocation destination is the A route that the vehicle 1 was circuiting (S104).

The load accumulated amount of each of the plurality of vehicles is calculated (S106), and since the acquired route A is the high load traveling route (YES in S108), the vehicle with the low accumulated amount is set as the allocated vehicle (S110). Then, the travel plan information is transmitted to the vehicle set as the allocated vehicle (S114).

After receiving the travel plan information, the allocated vehicle circulates each boarding/alighting point on the A route by autonomous driving in accordance with the order and departure/arrival times included in the travel plan information.

For example, it is assumed that the vehicle 4, which is circuiting route B, of the plurality of vehicles is determined to be in a state requiring maintenance by the self-diagnostic processing.

At this time, when management server 7 receives information indicating that maintenance is required from vehicle 4, it determines that there is a vehicle allocation request (YES in S100). Therefore, the operation information is acquired from the plurality of vehicles (S102), and it is acquired that the traveling route of the vehicle allocation destination is the B route that the vehicle 4 was circuiting (S104).

The load accumulated amount of each of the plurality of vehicles is calculated (S106), and since the acquired route B is a low load traveling route (NO in S108), the vehicle with the high accumulated amount is set as the allocated vehicle. (S112). Then, the travel plan information is transmitted to the vehicle set as the allocated vehicle (S114).

After receiving the travel plan information, the allocated vehicle circulates each boarding/alighting point on the B route by autonomous driving in accordance with the order and departure/arrival times included in the travel plan information.

As described above, with the vehicle management system according to the present embodiment, since it is possible to make the accumulated amount of load in a plurality of vehicles uniform, the risk of failure due to concentration of the load on some vehicles can be mitigated. As a result, it is possible to avoid unexpected maintenance from being performed, and suppress an increase in the time that cannot be used to provide the service. Therefore, it is possible to provide a vehicle management system that suppresses an increase in time that cannot be used to provide the service.

Furthermore, the management server 7 can accurately calculate the accumulated amount of the load of each of the plurality of vehicles by using the travel history of the plurality of vehicles.

Hereinafter, modifications will be described.

In the above-described embodiment, described as an example is a case in which a transportation service is provided, in which each of a plurality of vehicles circulates a predetermined traveling route and circulates each boarding/alighting point on a traveling route in accordance with a predetermined departure and arrival time. However, for example, when a transportation service is provided in which one of a plurality of vehicles moves from a waiting place to a position where a user gets on, then moves to a place specified by the user, and returns to the waiting place after the user gets off, a vehicle with a low accumulated amount may be assigned to a traveling route with a high load, and a vehicle with a high accumulated amount may be assigned to a traveling route with a low load.

Furthermore, in the above-described embodiment, the description is such that the vehicle that is set as the allocated vehicle excludes a vehicle in a state where maintenance is required. For example, it may be set to further exclude vehicles that are circulating other traveling routes. Alternatively, when the allocated vehicle is set including vehicles currently patrolling and the vehicle patrolling another traveling route is selected as the allocated vehicle, a new allocated vehicle may be set for the other traveling route depending on the load of the other traveling route and the load accumulated amount of the other vehicle.

Furthermore, in the above-described embodiment, the position detection device of the vehicle 1 is provided in the ADK 2 as an example. However, the position detection device may be provided in the VP 3.

Furthermore, in the above-described embodiment, a case where a plurality of traveling routes are classified into two stages of high load traveling routes and low load traveling routes has been described as an example. However, the plurality of traveling routes may be classified in accordance with a load degree of three or more stages. In this case, when it is determined that the traveling route is neither a high load traveling route nor a low load traveling route, the allocated vehicle may be set regardless of the accumulated amount.

In addition, the above-mentioned modifications may be carried out by appropriately combining all or a part thereof.

The embodiment disclosed herein should be considered to be exemplary and not restrictive in all respects. The scope of the present disclosure is shown by the scope of claims rather than the description above, and is intended to include all modifications within the meaning and the scope equivalent to the scope of claims.

What is claimed is:

1. A vehicle management system comprising:
a plurality of vehicles used to provide a transportation service; and
a server that is able to communicate with the vehicles,
wherein the server
calculates an accumulated amount of a load of each of the vehicles when provision of the transportation service using the vehicles on a plurality of traveling routes is required, and
allocates a vehicle in which the accumulated amount is large among the vehicles with priority over a vehicle in which the accumulated amount is small, for a traveling route in which a load degree indicating a degree of a load acting on the vehicle when the vehicle is traveling, among the traveling routes.

2. The vehicle management system according to claim 1, wherein the server calculates the accumulated amount of the load of each of the vehicles by using a travel history of each of the vehicles.

3. The vehicle management system according to claim 1, wherein the vehicle includes an autonomous driving vehicle.
